(19) United States
(12) Patent Application Publication
(10) Pub. No.: US 2002/0161454 A1
(43) Pub. Date: Oct. 31, 2002

(54) Information processing system, information processing apparatus, information terminal, and method for control thereof

(76) Inventors: Masaki Mukai, Nishinomiya-shi (JP); Atsushi Tanaka, Moriguchi-shi (JP); Osamu Sameshima, Moriguchi-shi (JP); Osamu Kamo, Kobe-shi (JP); Akira Ito, Nagaokakyo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/842,189

(22) Filed: Apr. 26, 2001

(51) Int. Cl. G05B 11/01; G05B 15/00

(52) U.S. Cl. 700/12; 700/17; 700/83; 700/19

(57) ABSTRACT

Disclosed are the information processing apparatus, its system, and method for control of the apparatuses capable preventing surreptitious reading, falsifying and erasing of data stored in the apparatuses. The system comprises information processing apparatus, portable apparatus and other information terminals having radio transmitting and receiving units. It is judged whether the distance between the two apparatuses is within a predetermined range or not by means of radio field strength detector or global positioning system (GPS). If not existing within a predetermined range or the password is not matched, some of the operations of at least one of the two apparatuses are stopped, or start of the two apparatuses is stopped.

### FIELD OF THE INVENTION

The present invention relates to an information processing system including plural devices for radio communications, an information processing system comprising a global positioning system (GPS), and a method for control of these systems.

### BACKGROUND OF THE INVENTION

In the communication field, recently, the radio communication technology and its devices are offered at lower prices, the information processing apparatus and system are widely spreading for making radio communications between personal computers (PCs), between a PC and peripheral devices, or between information terminals other than PCs, and transmitting information and controlling devices.

In particular, as a result of enhancement of integration technology of electronic components, development of small and high performance batteries, and development of new materials for use in the casing, the apparatus is smaller in size and lighter in weight, and is further advanced in portability. Accordingly, opportunities of digital radio communications between a portable device and a stationary device are increasing.

In such manner of use, a portable device “A” sends an instruction to an installed device “B” by radio communication. The device “B” processes according to the instruction, and sends the result to the device “A”. It seems as if all operations were done in the portable device “A” only.

In this conventional system, however, the device installed at a remote place may be stolen, or the important data may be read, falsified, or erased surreptitiously.

Besides the portable device, which is smaller and lighter than a desktop computer, may be lost or stolen easily. In the same manner as in the case of the installed device, the important data may be read, falsified, or erased surreptitiously.

### SUMMARY OF THE INVENTION

In the light of the above problems, it is hence an object of the invention to present information processing system and apparatus and its control method capable of preventing surreptitious reading, falsifying and erasing of data.

For this purpose, in the event of communication failure between information devices due to trouble in radio communication system or the like during information processing by using radio communications between the information devices, the data display and input operation in the information devices are stopped.

The information processing system of the invention is an information processing system containing an information processing apparatus having a radio transmitting and receiving unit, and an information terminal such as a portable device. A measuring unit of the strength of radio wave transmitted from the information terminal and received in the information processing apparatus is provided in the information processing apparatus. It is judged if the strength of the received radio wave is within a predetermined range or not. If the strength is not within the predetermined range, an out-of-range informing signal is generated, and the function of the information processing apparatus is stopped, or a start of the information processing apparatus is locked.

Also, by disposing a received wave strength measuring unit in the information terminal, similarly, the operation of the information terminal may be stopped or its start may be locked.

Further, instead of the received wave strength measuring unit, a GPS receiver may be installed in the apparatus so that the present position of the apparatus can be detected. Judging if the present position is within a predetermined range or not, if the result shows out of the predetermined range, an out-of-range informing signal is generated. As a result, in the apparatus incorporating the GPS, the operation of the apparatus may be stopped or its start may be locked.

Moreover, by transmitting a password by the radio transmitting and receiving unit, it may be designed to start and stop the operation of the function of the receiving side apparatus, or start and stop the apparatuses totally.

Further a GPS receiver may be installed in a single device, and the present position of the device may be detected to judge if the present position is within a predetermined range or not. Depending on the result, it may be designed to start and stop the operation of the function of this apparatus, or start and stop the apparatuses totally.

The apparatus control method includes the steps corresponding to the above modes of the information processing system and apparatus.

Thus, according to this information processing system and apparatus control method, if two information processing devices for mutual radio communications are not in the predetermined range, or if the received password is not matched, the function of the apparatus is stopped, or starting of whole apparatuses is stopped. It hence prevents surreptitious reading, falsifying and erasing of the data stored in the apparatuses.

### BRIEF DESCRIPTION OF THE DRAWINGS

FIG. 1A is a block diagram of information processing system in embodiment 1 of the invention.

FIG. 1B is a block diagram of other example of information processing system in embodiment 1 of the invention.

FIG. 2 is a flowchart showing the operation control method in embodiment 1 of the invention.

FIG. 3A is a block diagram of information processing system in embodiment 2 of the invention.

FIG. 3B is a block diagram of other example of information processing system in embodiment 2 of the invention.

FIG. 4 is a flowchart showing the operation control method in embodiment 2 of the invention.

FIG. 5 is a block diagram of information processing apparatus in embodiment 3 of the invention.

FIG. 6 is a flowchart showing the operation control method in embodiment 3 of the invention.

### DESCRIPTION OF THE PREFERRED EMBODIMENTS

Referring now to the drawings, preferred embodiments of the invention are described in detail below.

(Embodiment 1)

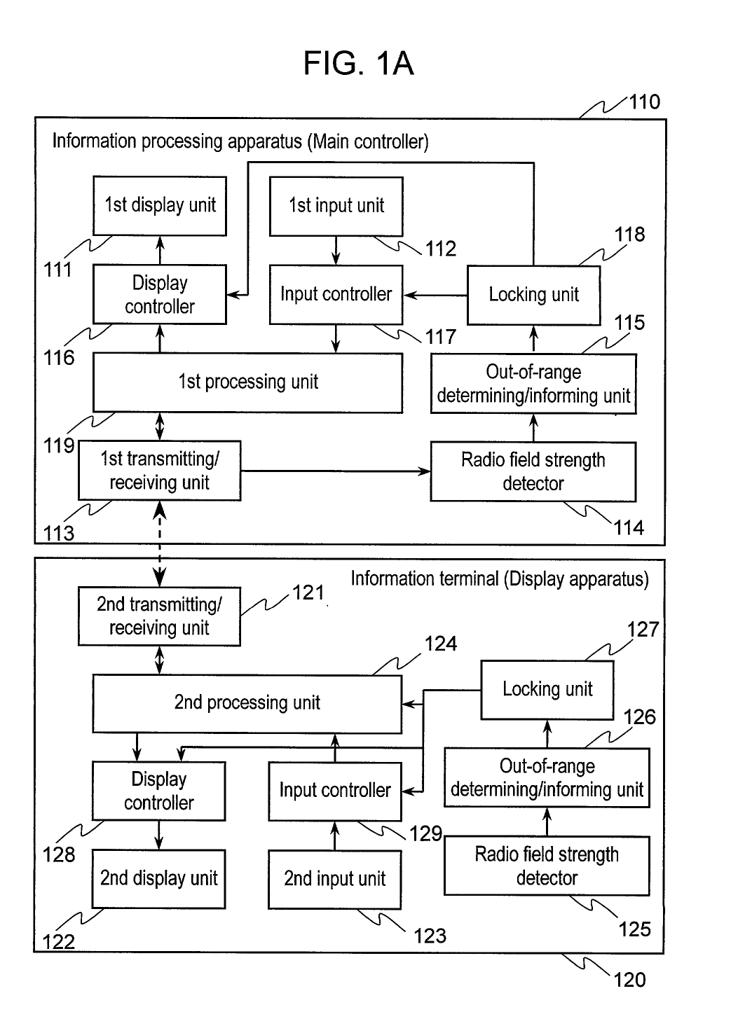

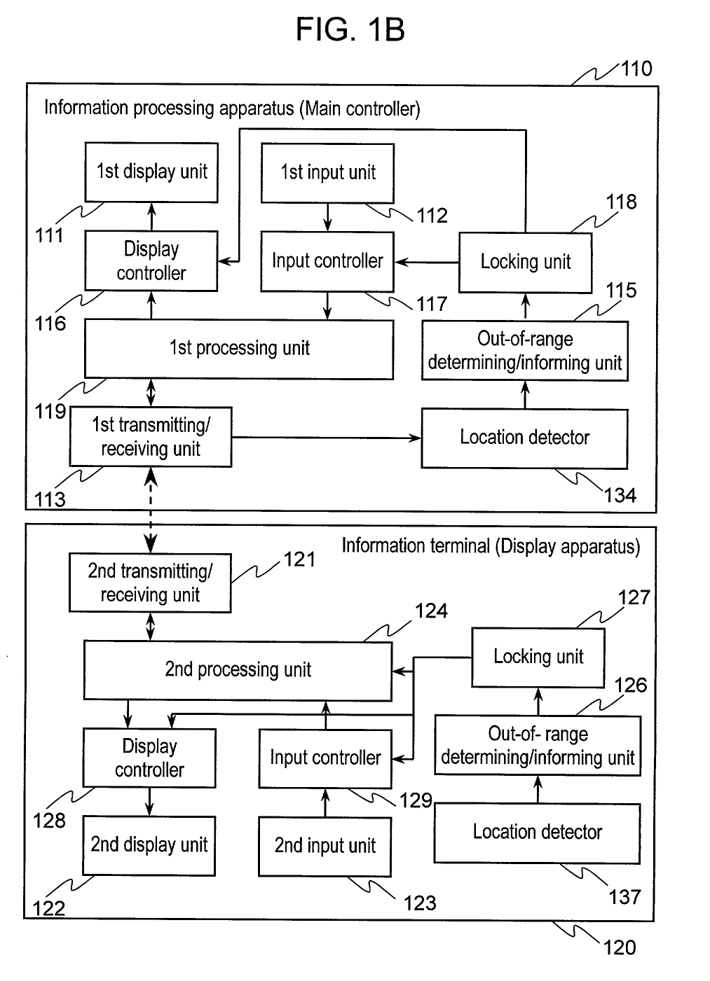

FIG. 1 is a block diagram of information processing system in embodiment 1 of the invention.

In FIG. 1A, an information processing apparatus 110 working as a main controller generates an image signal by specified signal processing, and transmits the image signal to an information terminal 120 which is an image display device by using ratio wave from a first transmitting and receiving unit 113. The information terminal 120 receives this radio wave in a second transmitting and receiving unit 121, decodes the radio wave into an image signal, and displays the signal as an image in a second display unit 122.

The first display unit 111 is a CRT or liquid crystal display (LCD), and the like. The displayed image is transmitted from the information processing apparatus 110 into the information terminal 120 without any changes. A first input unit 112 includes a keyboard and a mouse, and is manipulated by the user for input operation.

The first transmitting and receiving unit 113 not only transmits the image signal to the apparatus 120 as mentioned above, but also receives the operation signal from the apparatus 120. The operation signal is generated by the user's input manipulation in the second input unit. A radio field strength detector 114 measures the reception strength when the radio wave transmitted from the apparatus 120 is received in the apparatus 110 at a predetermined time interval.

Based on the measuring result of the detector 114, an out-of-range determining and informing unit 115 judges if the received radio wave strength is within a normal radio communication range for the apparatus 110 and apparatus 120. If out of the range, the out-of-range determining and informing unit 115 judges that the apparatus 120 is out of range, and generates an out-of-range informing signal, and outputs the signal to a locking unit 118. The locking unit 118 instructs stopping of display and invalidity of input to a display controller 116 and an input controller 117. Responsive to the instruction, the display controller 116 and input controller 117 stop the display of the first display unit 111 and invalidate the input from the first input unit 112. At this time, alternatively, starting of the information processing apparatus 110 may be stopped.

The first processing unit 119 processes the user's operation signal input from the first input unit 112 through the input controller 117, and the user's operation signal input from the second input unit 123 through the transmitting and receiving units 121 and 113. The unit 119 generates image signals of moving image, still image and text, and outputs them to the first display unit 111 through the display controller 116.

Receiving this image signal, a desired image is displayed in the first display unit 111.

This image signal is also transmitted to the apparatus 120 through the first transmitting and receiving unit 113, and the same image is displayed in the second display unit 122, in the same manner as mentioned above.

The second transmitting and receiving unit 121 receives the image signal generated in the apparatus 110, and transmits the operation signal generated in the apparatus 120 by means of radio wave.

The second display unit 122 is an LCD or the like, and the second input unit 123 is a touch panel or the like.

The second processing unit 124 generates an image signal from the reception signal from the second transmitting and receiving unit 121, and outputs the image signal to the second display unit 122. Also the unit 124 outputs the operation signal to the second transmitting and receiving unit 121. The operation signal is generated by the user's input operation received in the second input unit 123.

In the information processing system of the embodiment, it is supposed that the information processing apparatus 110 is installed in a specified place, and the information terminal 120 is carried, and is usually used in a place remote from the apparatus 110.

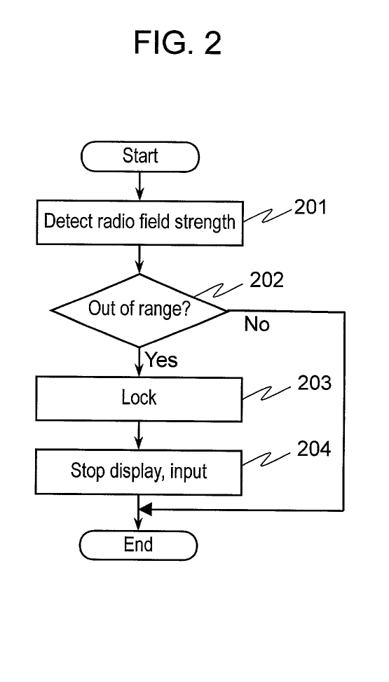

In the information processing system of the embodiment having such configuration, the operation of the information processing apparatus 110 after the radio field strength detector 114 measures the received radio wave strength is explained according to the flowchart in FIG. 2.

Step 201:

The radio field strength detector 114 measures the radio wave strength and evaluates, for example, as “L”. Then the process proceeds to step 202.

Step 202:

The out-of-range determining and informing unit 115 judges if the radio wave strength “L” is out of range or not. The process goes to step 203 if out of range, and the process terminates otherwise.

Step 203:

The locking unit 118 instructs stopping of display and inputting to the display controller 116 and input controller 117. The process proceeds to step 204.

Step 204:

The display controller 116 stops the output of the image to the first display unit 111, and the input controller 117 invalidates the input operation of the user from the first input unit 112. Then the process terminates.

Thus, according to the embodiment, the radio field strength detector 114 judges if the radio communication with the information terminal 120 is enabled or not at a predetermined time interval. If judging out of range and unable to communicate by radio, the display of image from the first display unit 111 and user input operation from the first input unit 112 provided in the information processing apparatus 110 are invalidated.

Therefore, if the units fail in communication each other while the information processing apparatus 110 is installed in a specified place and the information terminal 120 is being carried, operation for surreptitious reading, falsifying and erasing of data at the information processing apparatus 110 side can be prevented. If the information processing apparatus 110 itself is stolen, the internal data can be protected.

In this embodiment, in the combination of information processing apparatus and information terminal, if the units fail in communication each other, display and input of the information processing apparatus are stopped.

In the case that the information terminal side is provided with radio field strength detector 125, out-of-range determining and informing unit 126, locking unit 127, display controller 128 and input controller 129; and the both side fail in communication, it may be also designed to stop display and input at the information terminal.

In such a system, if the portable information terminal (image display device) is lost, operation for surreptitious reading, falsifying and erasing of data can be also prevented.

In the embodiment, on the occasion of failure in communication between the information processing apparatus (main controller) and information terminal (image display device), it is designed to stop display and input. As shown in FIG. 1B, the information processing apparatus or information processing apparatus may be provided with a GPS receiver as location detector 134 or 137. The display may be stopped and the input may be invalidated if the position measured by the GPS receiver is out of a specified range.

In this case, too, the display and input can be stopped in the apparatus provided with the GPS receiver, or in other apparatus.

In the embodiment, if failing in communication, it is designed to stop the display and input in the midst of process. It may be also designed not to start if a third party attempts to start operation by using other starting means.

(Embodiment 2)

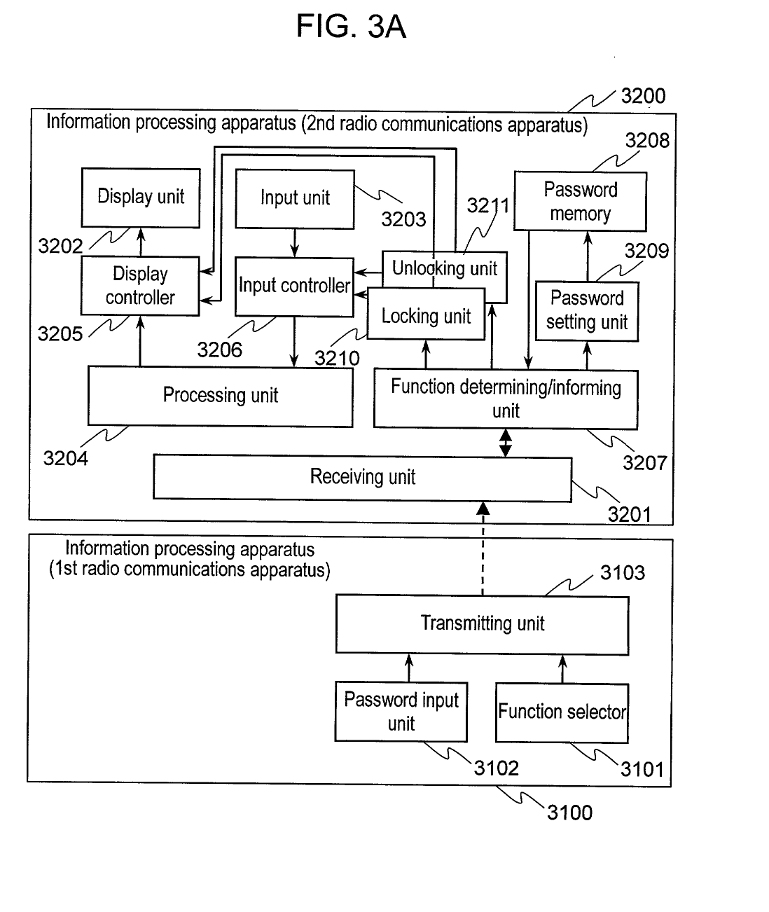

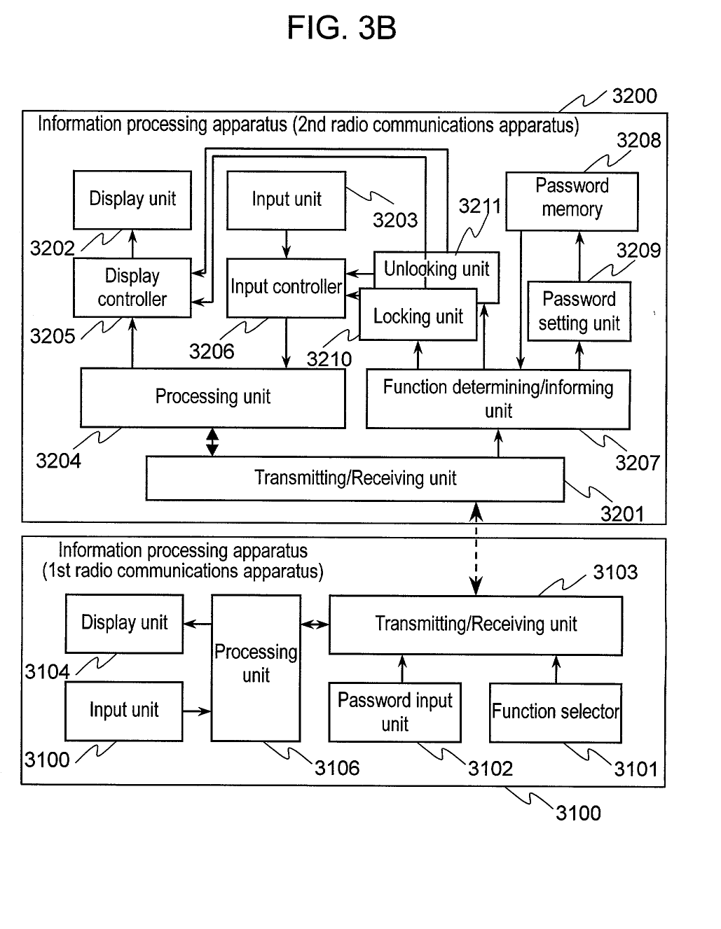

FIG. 3A is a block diagram of an information processing system in embodiment 2 of the invention.

An information terminal 3100 which is a first radio communication apparatus includes a function selector 3101, a password input unit 3102, and a transmitting unit 3103.

The function selector 3101 has a function of locking operation, unlocking operation, or setting password, according to the user's instruction.

Herein, the object of locking or unlocking of operation is an information processing apparatus 3200 which is a second radio communication apparatus. Similarly, the password is used for unlocking the operation of the information processing apparatus 3200.

The password input unit 3102 receives input of password from the user.

The transmitting unit 3103 transmits the signal generated in at least one of the function selector 3101 and the password input unit 3102 to the information processing apparatus 3200 by radio wave.

A receiving unit 3201 of the information processing apparatus 3200 receives the radio wave signal transmitted from the information terminal 3100.

A display unit 3202 displays data such as an image including a moving image and a still image and a text to the user. An input unit 3203 accepts input operation by the user.

A processing unit 3204 processes the operation signal generated by the input operation of the user in the input unit 3203, and displays the result of processing in the display unit 3202.

A display controller 3205 controls whether to stop or start display of the image or other data output by the processing unit 3204 according to the instruction of a locking unit 3210 or an unlocking unit 3211 in the display unit 3202.

An input controller 3206 makes the user's input operation in the input unit 3203 valid or invalid depending on the instruction of the locking unit 3210 or unlocking unit 3211.

A function determining unit 3207 judges the data received in the receiving unit 3201 either the function of locking or unlocking operation or setting the password. Accordingly, the determining unit 3207 instructs locking or unlocking of operation of the information processing apparatus 3200 or setting of password to the locking unit 3210, unlocking unit 3211, or password setting unit 3209. If the instructed function is unlocking, the received password and the content in the password memory 3208 are collated, and when matched, unlocking of operation is instructed to the unlocking unit 3211.

Receiving this instruction, the unlocking unit 3211 instructs unlocking of operation to the display controller 3205 and input controller 3206, and unlocks the display unit 3202 and input unit 3203.

If the password is not matched, locking of operation is instructed to the locking unit 3210.

Receiving this instruction, the locking unit 3210 instructs locking of operation to the display controller 3205 and input controller 3206, and locks the display unit 3202 and input unit 3203. When a locking function is instructed, the display unit 3202 and input unit 3203 are locked.

The password memory 3208 stores the password necessary for unlocking the operation by the unlocking unit 3211.

The password setting unit 3209 changes the content, that is, the password in the password memory 3208 according to the instruction of the function determining unit 3207.

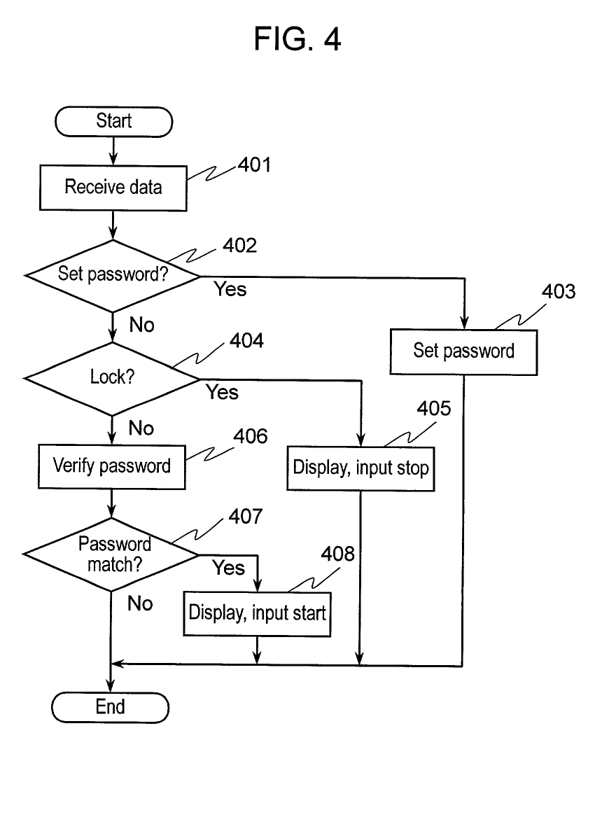

In the information processing system of the embodiment having such a configuration, the operation when the information processing apparatus 3200 receives the data transmitted from the information terminal 3100 is explained according to the flowchart in FIG. 4.

Step 401:

The receiving unit 3201 receives data, for example, “D” transmitted by radio communication from the information terminal 3100, and the process goes to step 402.

Step 402:

The function determining unit 3207 judges if the function type of data “D” is setting of password or not, and if Yes, password “P” is taken out from data “D”, and the process goes to step 403, or otherwise the process goes to step 402.

Step 403:

The function determining unit 3207 instructs registration of password “P” to the password setting unit 3209, and the password setting unit 3209 stores the password in the password memory 3208 according to the instruction, and the process is terminated.

Step 404:

The function determining unit 3207 judges if the function type of data “D” is locking of operation or not, and if Yes, the process goes to step 405, or otherwise the process goes to step 406.

Step 405:

The locking unit 3210 instructs locking of operation to the display controller 3205 and the input controller 3206, and the display controller 3205 and the input controller 3206 stop display and input of the display unit 3202 and the input unit 3203 respectively according to the instruction, and the process is terminated.

Step 406:

The function determining unit 3207 takes out password “P” from data “D”, and compares password “P” and the contents in the password memory 3208, and goes to step 407.

Step 407:

When the password is matched, the process goes to step 408, or otherwise the process is terminated.

Step 408:

The function determining unit 3207 instructs unlocking of operation to the unlocking unit 3211. Accordingly, the unlocking unit 3211 instructs unlocking of operation to the display controller 3205 and the input controller 3206.

The display controller 3205 starts display of the display unit 3202 and the input controller 3206 starts input of the input unit 3203 according to the instruction, and the process is terminated.

Thus, according to the embodiment, from the information terminal 3100, the user sends the operation of locking or unlocking of operation of the information processing apparatus 3200 or setting of password by radio communication to the information processing apparatus 3200. After judging the function by the function determining unit 3207, the process based on the judging result is realized by the locking unit 3210, unlocking unit 3211, or password setting unit 3209. Therefore, when the information terminal 3100 is carried by the user and the information processing apparatus 3200 is installed at a place remote from the user, or if the information processing apparatus 3200 is lost or stolen, its operation can be locked or unlocked, or the password can be set by the user from the information terminal. It hence avoids ill-willed operation by third party for surreptitious reading, falsifying or erasing the data in the information processing apparatus 3200.

In the embodiment, the password stored in the password memory is used for unlocking the information processing apparatus from the information terminal which is the first radio communication apparatus.

The same password may be also used for unlocking from the information processing apparatus which is the second radio communication apparatus.

Or, as shown in FIG. 3B, at the information terminal, in addition to the function selector and the password input unit, a display unit 3104 for displaying the image, an input unit 3105 for accepting user's general input operation, and a processing unit 3106 for processing these signal may be also provided.

(Embodiment 3)

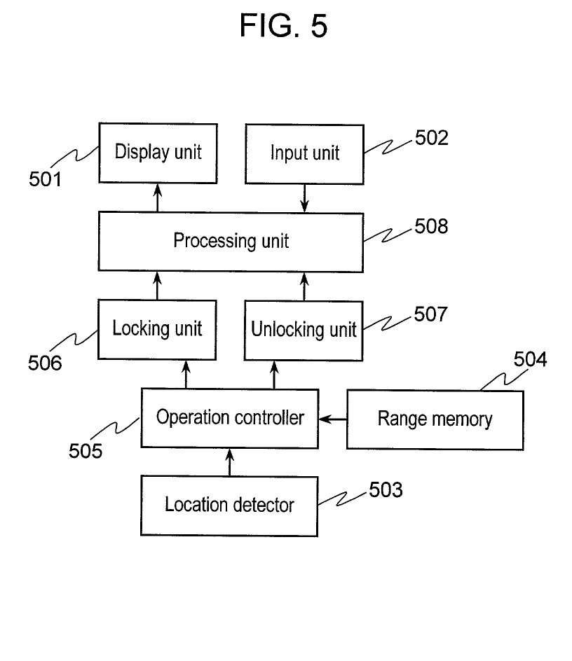

FIG. 5 is a block diagram of an information processing apparatus in embodiment 3 of the invention.

In FIG. 5, a display unit 501 is a CRT, an LCD or the like, and displays specified images or text.

An input unit 502 includes a keyboard and a mouse, and accepts user's input operation.

A location detector 503 is connected to a GPS receiver or incorporates a GPS receiver, and calculates the own location at a predetermined time intervals, and outputs the present position.

The output data contains latitude, longitude, altitude, and others, but in the embodiment, only the latitude and longitude are used, and expressed to the third decimal point.

An range memory 504 stores the usable range of the information processing apparatus in the embodiment of the invention in terms of latitude and longitude.

The content can be changed by proper means (not shown). An operation controller 505 judges if the output data of the location detector 503 is within a predetermined range stored in the range memory 504 or not. The operation controller 505 informs the judging result to a locking unit 506 or an unlocking unit 507.

If the present position is out of specified range, an instruction is given to the locking unit 506 to stop the operation of a processing unit 509, and the apparatus is disabled. Otherwise, an instruction is given to the unlocking unit 507, and the operation of the processing unit 509 is started, so that the apparatus is enabled.

A processing unit 508 processes according to the input of user's operation from the input unit 502, and outputs, if necessary, images including a moving image and a still image, and text to the display unit 501.

The operation of the processing unit 508 is stopped or started by the instruction from the locking unit 506 or unlocking unit 507.

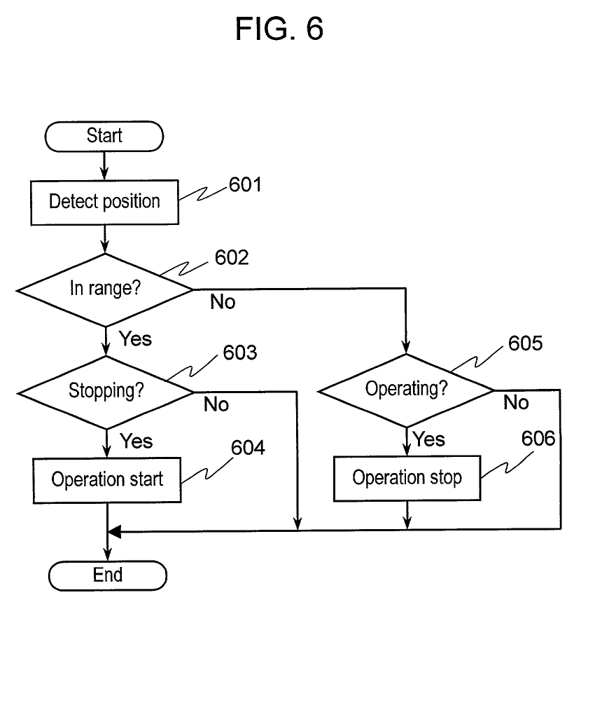

In the information processing apparatus of the embodiment having such a configuration, the operation after the location detector 503 detects the position is explained according to the flowchart in FIG. 6.

Step 601:

The location detector 503 detects the present position of the information processing apparatus as, for example, “P”, and the process goes to step 602.

Step 602:

The operation controller 505 judges if the present position is within the predetermined range stored in the range memory 504 or not, and if within the predetermined range, the process goes to step 603, and if out of the range, the process goes to step 605.

Step 603:

The unlocking unit 507 checks if the processing unit 508 is stopped or not, and if stopped, the process goes to step 604, or if operating, the process is terminated.

Step 604:

The unlocking unit 507 instructs a start of operation to the processing unit 508, and terminates the process.

Step 605:

The locking unit 506 checks if the processing unit 508 is operating or not, and if operating, the process goes to step 606, and if stopped, the process is terminated.

Step 606:

The locking unit 506 instructs stopping of operation to the processing unit 508, and terminates the process.

For example, suppose the information processing apparatus of the embodiment is used in an office. The office is located at east longitude of 135 degree 34.350 min., and north latitude of 34 degree 44.550 min., and the range memory 504 is supposed to store the data of “east longitude of 135 degree 34.300 min. to 135 degree 34.400 min., and north latitude of 34 degree 44.500 min. to 34 degree 44.600 min.,”. Then, the apparatus operates normally in the office, but if it is taken out of the office by an ill-willed third party and moved to a place several hundreds meters away, it does not work, hence subsequent illegal uses can be prevented.

Thus, according to the embodiment, the location detector detects the own present position at a predetermined time intervals, and the apparatus is operated when within a predetermined range, and stopped if out of the range. It therefore prevents removal of the apparatus by third party, or surreptitious operation for reading, falsifying or erasing data in the apparatus.

In the embodiment, depending on the output of the location detector, examples of changing from an operating state to a stopped state, or from the stopped state to the operating state are shown. Alternatively, if the output of the location detector is out of the predetermined range, it may be designed to control so that the power source of the information processing apparatus cannot be turned on.

As described herein, according to the invention, in the system comprising apparatuses for mutual radio communication, if one apparatus is judged to be out of a predetermined range by measurement of received radio wave strength or detection of present position of apparatus by GPS, the operation of this apparatus is locked. It prevents third party's mischievous operation for reading, falsifying or erasing data surreptitiously. Also in the system comprising apparatuses for mutual radio communication, from the apparatus of the user's side, locking or unlocking of operation and setting of password of the other apparatus can be instructed. It similarly prevents operation for reading, falsifying or erasing data surreptitiously.

Moreover, in an independent apparatus incorporating a GPS receiver, if the apparatus is out of a predetermined range, its operation is locked, or its start is stopped. Thus, if the apparatus is stolen and moved to a remote place, possibility of third party's surreptitious operation for reading, falsifying or erasing data can be avoided.

What is claimed is:

1. An information processing apparatus comprising:
a) a locking unit for stopping one of a start and a function of said information processing apparatus, and
b) means for operating said locking unit responsive to at least one of an incoming signal from a communication apparatus and a signal indicating a position of said information processing apparatus.

2. An information terminal for making radio communication with an information processing apparatus comprising:
a′) an input unit for accepting an input operation, and
b′) a communication unit for at least one of transmitting and receiving,
wherein said communication unit sends a signal to said information processing apparatus according to the input to said input unit.

3. An information processing system for making radio communication comprising:
(1) an information processing apparatus, and
(2) an information terminal for making radio communication with said information processing apparatus,
wherein said information processing apparatus comprises:
a) a transmitting and receiving unit for making radio communication,
b) a locking unit for stopping one of a start and a function of said information processing apparatus, and
c) means for operating said locking unit responsive to at least one of an incoming signal from the transmitting and receiving unit and a signal indicating the position of said information processing apparatus,
said information terminal comprises:
a′) an input unit for accepting an input operation, and
b′) a communication unit for at least one of transmitting and receiving, and
the communication unit sends a signal to said information processing apparatus according to the input to the input unit.

4. The information processing apparatus of claim 1, further comprising:
c) a transmitting and receiving unit for making radio communication with the communication apparatus,
d) a radio field strength detector for measuring a reception strength of a signal received in said transmitting and receiving unit, and
e) an out-of-range determining and informing unit for judging the reception strength, and sending an out-of-range notice signal to the locking unit when the reception strength is out of a predetermined range,
wherein the out-of-range determining and informing unit functions as means for operating the locking unit.

5. The information terminal of claim 2, further comprising:
c′) a display unit for displaying at least one of image and text received from the information terminal,
d′) a locking unit for stopping either start or function of the information terminal,
e′) a radio field strength detector for measuring the reception strength of the radio signal received from the information processing apparatus, and
f′) an out-of-range determining and informing unit for judging the reception strength, and sending an out-of-range notice signal to the locking unit when the reception strength is out of a predetermined range,
wherein said out-of-range determining and informing unit operates said locking unit, and said locking unit makes one of stopping at least one of said display unit and said input unit, and stopping the start of said information terminal.

6. The information terminal of claim 2, further comprising:
c′) a display unit for displaying at least one of image and text received from said information processing apparatus,
d′) a location detector for detecting a position by using a global positioning system, and
e′) a locking unit for stopping one of a start and a function of said information terminal,
wherein said locking unit, responsive to a position detected by said location detector, makes one of stopping at least one of the display unit and the input unit, and stopping a start of said information terminal.

7. The information terminal of claim 2, further comprising:
c′) a location detector for detecting a position by using a global positioning system (GPS), and
d′) an out-of-range determining and informing unit for outputting a signal to be noticed to said information processing apparatus, in the case a position detected by said location detector is out of a predetermined range, so that said information processing apparatus stops one of a start and a function thereof.

8. The information processing system of claim 3,
wherein said information terminal further comprises:
c′) a location detector for detecting the position by using a global positioning system (GPS), and
d′) an out-of-range determining and informing unit for outputting a notice signal to said information processing apparatus to the communication unit if the position detected by the location detector is out of a predetermined range,
said information processing apparatus further comprises:
d) an input unit for accepting an input operation, and
e) a display unit for displaying at least one of image and text responsive to the input operation, and
the locking unit, responsive to the notice signal, makes one of stopping at least one of the display unit and the input unit of said information processing apparatus, and stopping a start of said information processing apparatus.

9. The information processing apparatus of claim 1, further comprising:
c) a transmitting and receiving unit for making radio communication with the communication apparatus, and
d) a password memory for storing a password according to the signal received in the transmitting and receiving unit,
wherein one of starting said information processing apparatus, and starting the operation of its function is started, when the password stored in the password memory is matched with the password received from the information terminal.

10. The information terminal of claim 2,
wherein said input unit i) receives instruction for locking of operation, unlocking of operation, or setting of password, and ii) receives input of password, and said communication unit transmits data received in the input unit to said information processing apparatus in order to control said information processing apparatus.

11. The information processing system of claim 3,
wherein said input unit of the information terminal i) receives instruction for locking of operation, unlocking of operation, or setting of password, and ii) receives input of password, and said communication unit transmits data received in said input unit to said information processing apparatus in order to control said information processing apparatus,
said information processing apparatus further comprises:
d) a password memory for storing a password according to the signal received from said information terminal, and
e) an unlocking unit for making one of starting said information processing apparatus and starting the operation of its function when the password stored in the password memory is matched with a further password received from said information terminal, and
the locking unit operates according to a signal received from said information terminal, and allows one of a start and a function of said information processing apparatus to be stopped.

12. The information processing apparatus of claim 1, further comprising:
c) a location detector for detecting the position by using a global positioning system (GPS),
d) an range memory for preliminarily storing a usable range of said information processing apparatus, and
e) an unlocking unit for making one of starting said information processing apparatus and starting the operation of its function,
wherein if the position detected by the location detector is out of a predetermined range, the locking unit stops one of a start and a function of said information processing apparatus, and if the position detected by the location detector is within the predetermined range, the unlocking unit implements one of starting said information processing apparatus and starting the operation of its function.

13. The information processing apparatus of claim 12, further comprising:
f) an input unit for accepting an input operation, and
g) a display unit for displaying at least one of image and text responsive to the input operation,
wherein i) if a position detected by the location detector is out of the predetermined range, the locking unit makes one of stopping at least one of the display unit and the input unit, and stopping a start of said information processing apparatus, and ii) if the position detected by the location detector is within the predetermined range, the unlocking unit makes one of starting at least one of the display unit and the input unit, and starting the information processing apparatus.

14. A control method for information processing apparatus comprising the steps of:
a) generating a signal responsive to at least one of an incoming signal from a communication apparatus and a signal indicating a position of said information processing apparatus, and
b) stopping one of a start thereof and a function thereof responsive to the signal.

15. A control method for information terminal for making radio communication with an information processing apparatus comprising the steps of:
a′) accepting an input operation, and
b′) implementing at least one of transmitting and receiving,
wherein the communication unit sends a signal to said information processing apparatus responsive to an input to the input unit.

16. A control method for information processing system for making radio communication mutually between an information processing apparatus and an information terminal,
in said information processing apparatus said control method comprising the steps of:
a) generating a signal responsive to at least one of an incoming signal from said information terminal and a signal indicating a position of said information processing apparatus, and
b) stopping one of a start and a function thereof responsive the signal,
in said information terminal, said control method comprising the steps of:
a′) accepting an input operation, and
b′) implementing at least one of transmitting and receiving, and
the communication unit sends a signal to the information processing apparatus responsive to the input to the input unit.

17. The control method for information processing apparatus of claim 14, further comprising the steps of:
c) making radio communication with the communication apparatus,
d) measuring a reception strength of a received signal, and
e) judging the reception strength, and stopping one of a start and a function of said information processing apparatus when the reception strength is out of a predetermined range.

18. The control method for information terminal of claim 15, further comprising the steps of:
c′) displaying at least one of image and text received from said information processing apparatus,
d′) measuring a reception strength of a radio signal received from said information processing apparatus,
e′) judging the reception strength, and sending an out-of-range notice signal when the reception strength is out of a predetermined range, and
f′) implementing one of stopping at least one of the display at step c′) and acceptance of the input operation, and stopping a start of said information terminal, responsive to the out-of-range notice signal.

19. The control method for information terminal of claim 15, further comprising the steps of:
c′) displaying at least one of image and text received from the information processing apparatus,
d′) detecting a position by using a global positioning system (GPS), and
e′) implementing one of stopping at least one of display at step c′) and acceptance of the input operation, and stopping a start of the information terminal, based on the position detected at step d′).

20. The control method for information terminal of claim 15, further comprising the steps of:
c′) detecting a position by using a global positioning system (GPS), and
d′) outputting a signal to notice said information processing apparatus, in case that the position detected at step c′) is out of a predetermined range, so that said information processing apparatus stops one of a start and a function thereof.

21. The control method for information processing system of claim 16,
wherein in said information terminal, said control method further comprises the steps of:
c′) detecting a position by using a global positioning system (GPS), and
d′) outputting a notice signal to said information processing apparatus to said information terminal if the position detected at step c′) is out of a predetermined range,
in said information processing apparatus, said control method further comprises the steps of:
c) displaying at least one of image and text, and
d) implementing one of stopping at least one of the display at step c) and acceptance of input operation, and stopping a start of said information processing apparatus, based on the notice signal.

22. The control method for information processing apparatus of claim 14, further comprising the steps of:
c) making radio communication with the communication apparatus,
d) storing a password responsive to the signal received at step c), and
e) implementing one of starting said information processing apparatus and starting operation of a function thereof, when the stored password is matched with a further password received from the communication apparatus.

23. The control method for information terminal of claim 15,
wherein step a′) further includes the steps of i) receiving instruction for locking of operation, unlocking of operation, or setting of a password, and ii) receiving input of a password, and step b′) further includes a step of transmitting the data received at step a′) to said information processing apparatus in order to control said information processing apparatus.

24. The control method for information processing system of claim 16,
wherein in said information terminal, step a′) further includes the steps of i) receiving instruction for locking of operation, unlocking of operation, or setting of a password, and ii) receiving input of a password, and, step b′) further includes a step of transmitting the data received at step a′) to said information processing apparatus in order to control said information processing apparatus, and
in said information processing apparatus, said control method further comprises the steps of:
c) accepting an input operation,
d) storing a password responsive to the signal received from the information terminal,
e) implementing one of starting said information processing apparatus and starting an operation of a function thereof when the password stored at step d) is matched with a further password received from the information terminal, and
f) stopping one of a start and a function of said information processing apparatus responsive to a signal received from the information terminal.

25. The control method for information processing apparatus of claim 14, further comprising the steps of:
c) detecting a position by using a global positioning system (GPS),
d) preliminarily storing an usable range of said information processing apparatus,
e) stopping one of a start and a function of said information processing apparatus, if the position detected at step c) is out of the stored range, and
f) implementing one of starting said information processing apparatus and starting operation of a function thereof, if the position detected at step c) is within the predetermined range.

26. The control method for information processing apparatus of claim 25, further comprising the steps of:
f) displaying at least one of image and text, and
g) accepting an input operation,
wherein i) if the position detected at step c) is out of the predetermined range, at step e), one of stopping at least one of the display at step f) and input operation, and stopping a start of said information processing apparatus is made, and ii) if the position detected at step c) is within the predetermined range, one of starting at least one of the display at step f) and acceptance of the input operation, and starting said information processing apparatus is made.
